(19) United States
(12) Patent Application Publication
(10) Pub. No.: US 2023/0286556 A1
(43) Pub. Date: Sep. 14, 2023

(54) AUTONOMOUS DRONE FOR RAILROAD TRACK INSPECTION

(71) Applicant: University of South Carolina, Columbia, SC (US)

(72) Inventors: Yu Qian, Irmo, SC (US); Yi Wang, Chapin, SC (US); Chen Chen, Orlando, FL (US)

(73) Assignee: University of South Carolina, Columbia, SC (US)

(21) Appl. No.: 18/179,691

(22) Filed: Mar. 7, 2023

Related U.S. Application Data
(60) Provisional application No. 63/317,652, filed on Mar. 8, 2022.

(51) Int. Cl. B61L 23/04; B64U 10/00; G08G 5/00; G08G 5/04; G05D 1/10; H04N 7/18; G06T 7/00; G06T 7/50

(52) U.S. Cl. CPC B61L 23/042; B64U 10/00; G08G 5/0069; G08G 5/045; G05D 1/106; H04N 7/183; G06T 7/0002; G06T 7/50; B64U 2201/10; B64U 2101/26

(57) ABSTRACT

Described herein is a fully autonomous drone-based track inspection system that does not rely on GPS but instead uses optical images taken from the drone to identify the railroad track and navigate the drone to cruise along the track to perform track inspection tasks; track images are taken by the onboard drone camera and processed to provide both navigation information for autonomous drone flight control and track component health evaluation.

### TECHNICAL FIELD

The subject matter disclosed herein is generally directed to a fully autonomous drone-based track inspection system that does not rely on GPS but instead uses optical images taken from the drone to identify the railroad track and navigate the drone to cruise along the track to perform track inspection tasks; track images are taken by the onboard drone camera and processed to provide both navigation information for autonomous drone flight control and track component health evaluation.

### BACKGROUND

Current railroad track inspection procedures and systems suffer from various drawbacks. Human pilot cost is significant. The schedule of the drone-based track inspection is contingent on the pilot's availability rather than that of drones or tracks. Also, the images collected by different pilots at the same track segment could vary and depend on the pilots' operation. The inspection route is subjective. Because the drones are controlled by pilots, the performance of the inspection route depends on the skill, experience, and judgment of the pilot. Upon image acquisition in the field, image data needs to be transferred back to a data center for analysis. The delay between data collection, data processing, and decision-making depreciates the value of the inspections because track conditions can quickly deteriorate as traffic accumulates.

Accordingly, it is an object of the present disclosure to provide improved systems and methods for railroad track inspection using autonomous drone systems and optical data obtained during drone flight.

Citation or identification of any document in this application is not an admission that such a document is available as prior art to the present disclosure.

### SUMMARY

The above objectives are accomplished according to the present disclosure by providing a drone-based railway track inspection system. The system may include at least one drone comprising at least one computing platform, the at least one computing platform may also include at least one surveillance unit, at least one communication unit, at least one computer vision unit; and at least one autonomous flight control unit. The at least one surveillance unit, at least one communication unit, the at least one computer vision unit, and the at least one autonomous flight control unit may be in communication with one another and the at least one computer vision unit may be configured to extract features of at least one track component to evaluate at least one health condition of the at least one track component and identify a least one railway in order for the at least one drone to navigate. Further, the drone may navigate without access to GPS positioning. Still yet, the at least one flight control unit may employ a real-time obstacle avoidance system. Further yet, the system may include an onboard processing unit that may process inspected data immediately to provide real-time track condition assessment without requiring the inspected data to transfer away from the drone. Still further, the at least one health condition of the at least one track component may include identifying at least one item missing from the at least one track component or identifying at least one defect in a rail surface. Further again, the system may include a data repository in communication with the at least one computing platform wherein the data repository contains field track appearance data to compare with real-time data obtained by the drone-based railway track inspection system. Yet again, the system may include an automatic landing control module in communication with the at least one computing platform to execute an emergency landing protocol. Again still, the system may include an object depth estimation module, in communication with the at least one computing platform, to detect at least one oncoming obstacle in a drone flight path as well as to determine a distance of the at least one oncoming obstacle to the drone. Further yet again, the system may include at least one non-edge-aware saliency detection framework, in communication with the at least one computing platform, to detect the rail surface under blurred, incomplete, or incorrect rail boundary visual information. Yet further still, the least one non-edge-aware saliency detection framework may be configured to reproduce the rail surface in real-time.

The disclosure may also provide a method for using a drone to inspect railway tracks. The method may include flying at least one drone over at least one railway, wherein the at least one drone may include at least one computing platform and the at least one computing platform may include at least one surveillance unit, at least one communication unit, at least one computer vision unit, and at least one autonomous flight control unit. The at least one surveillance unit, at least one communication unit, the at least one computer vision unit, and the at least one autonomous flight control unit may be in communication with one another. The at least one computer vision unit may be configured to extract features of at least one track component while flying over the at least one railway to evaluate at least one health condition of the at least one track component; and identify the at least one railway while flying over the at least one railway in order for the at least one drone to navigate. Further, the drone may navigate without access to GPS positioning. Still yet, the at least one flight control unit may employ a real-time obstacle avoidance system. Yet again, the at least one computing platform may include an onboard processing unit that processes inspected data immediately to provide real-time track condition assessment without requiring the inspected data to transfer away from the drone. Still yet further, the at least one health condition of the at least one track component may include identifying at least one item missing from the at least one track component or identifying at least one defect in a rail surface. Again further, the at least one computing platform may include a data repository in communication with the at least one computing platform wherein the data repository contains field track appearance data to compare with real-time data obtained by the drone-based railway track inspection system. Yet further still, the at least one computing platform may include an automatic landing control module to execute an emergency landing protocol. Further yet again, the at least one computing platform may include an object depth estimation module to detect at least one oncoming obstacle in a drone flight path as well as to determine a distance of the at least one oncoming obstacle to the drone. Yet still again, the at least one computing platform may include at least one non-edge-aware saliency detection framework to detect the rail surface under blurred, incomplete, or incorrect rail boundary visual information. Yet still again, the least one non-edge-aware saliency detection framework may be configured to reproduce the rail surface in real-time.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an overall concept map of a proposed AUTO-Inspection System of the current disclosure.

FIG. 2 shows an example of a drone-based track image collection for a training library of the current disclosure.

FIG. 3 shows one example of inspection development at: (a) missing component detection; and (b) new component detection.

FIG. 4 shows an example of rail surface detection from a drone with various viewing angles and height.

FIG. 5 shows a diagram of one embodiment of a quadcopter vision-based rail tracking system.

FIG. 6 shows an image-based visual servoing and autonomous control of a track-following robot of the current disclosure.

FIG. 7 shows a flowchart of railroad extraction and analysis of the current disclosure.

FIG. 8 shows photographs of a candidate open-source PX4 Vision quadcopter development kit.

FIG. 9 shows examples of image enhancement at: (a) enhancement for low visibility; (b) enhancement for rainy condition; and (c) left: object detection on the original rain image; right: object detection on the derained image.

FIG. 10 shows one potential architecture of the proposed image enhancement network.

FIG. 11 shows an unsupervised monocular depth estimation framework.

FIG. 12 shows an example of image-based object depth estimation.

FIG. 13 shows an illustration of the concepts to select the track at turnouts at: (a) Multi-track segmentation; and (b) track/Route selection concept.

FIG. 14 shows a Development Risk graph of the current disclosure.

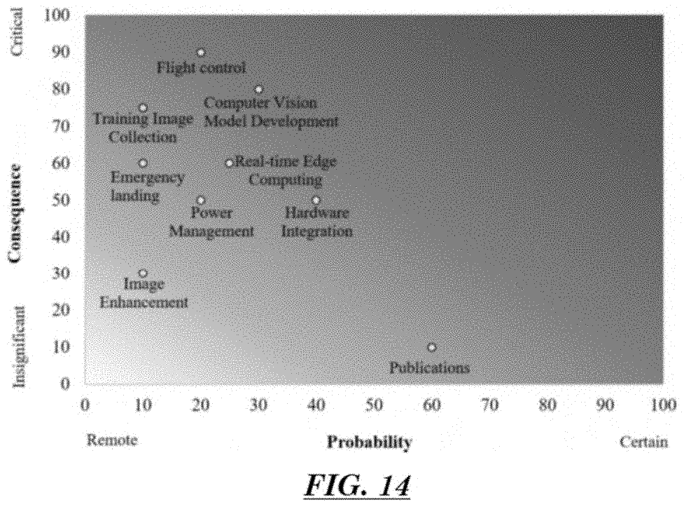

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the detection and analysis systems described herein can be presented as a combination kit. As used herein, the terms “combination kit” or “kit of parts” refers to the drones, optical and sensing systems, and any additional components that are used to package, sell, market, deliver, and/or analyze the systems and devices explained herein. When one or more of the components described herein or a combination thereof are provided simultaneously, the combination kit can contain the system in a single combination or separate combinations. When the drones, optical and sensing systems, and any additional components described herein or a combination thereof and/or kit components are not provided simultaneously, the combination kit can contain each component in separate combinations. The separate kit components can be contained in a single package or in separate packages within the kit.

In some embodiments, the combination kit also includes instructions printed on or otherwise contained in a tangible medium of expression. The instructions can provide information regarding the content of the kit and/or safety information regarding the content of the kit, information regarding usage, etc. In some embodiments, the instructions can provide directions and protocols for conducting analysis as described herein.

The objective of this disclosure is to develop a fully autonomous drone-based track inspection system. The proposed system will leverage extensive knowledge and expertise of the research team on autonomous systems, computer vision, and edge computing technologies for intelligent airspace navigation and track conditions evaluation.

The proposed system will be built on a modular architecture with the initial focus on inspections at low altitudes and within visual line of sight (VLOS), and later be extended to high attitude and beyond visual line of sight (BVLOS) while complying with both track inspection requirements and airspace regulations. The system will integrate the continuous surveillance unit, communication unit, computer vision and deep-learning/artificial intelligence (AI) unit, and autonomous flight control unit on a size, weight, and power (SWaP)-efficient edge computing platform to achieve superior inspection performance subjected to payload and power constrains. The success of this research will significantly boost track inspection efficiency, accuracy, and cost effectiveness over the existing practices.

With the advent of advanced sensors and data processing approaches, automated inspection methods have been developed for railroad track inspections. For example, Ensco has developed several onboard image-based inspection systems, such as the Track Component Imaging System and Rail Surface Imaging System, and the inspection schedule depends on the availability of the vehicles. Vision models were developed using images taken with consistent angles and good illumination conditions, which, however, lead to two main practical challenges: first, the accuracy is highly sensitive to the image quality, entailing precise camera installation and consistent image acquisition that are difficult to satisfy in the field environment (such as varied illumination conditions, different track appearances, and drastic vibration). Second, the vehicle availability and inspection schedules are typically very limited. Thus, alternative methods and platforms are strongly desired, such as handheld cameras, on-track robotics, and UAVs. There are a considerable number of studies to use UAVs in track inspection. For example, BNSF has used drones images to evaluate the structural health of a bridge above the Abo River. BNSF deployed drones during Hurricane Harvey to determine if it is safe to dispatch crews. NS used drones to evaluate the site safety after several derailments.

UPRR used drone images to allocate resources for better recovery from a flooding event in Iowa. In contrast to traditional, on-site inspections by human, drones allow safe and thorough inspections in dangerous or hard-to-access areas without interruptions of operations. However, all these earlier studies solely utilize drones as a carrier of cameras, human pilots are required to operate and control the drones.

To address these existing limitations and future track inspection needs, we propose to develop the next generation, smart drone-based track inspection platform with the following main features: 1) fully autonomous flight control, 2) obstacle avoidance, 3) advanced computer vision for real-time situational awareness; and 4) efficient edge computing for field data processing. The advanced, embedded computer vision model will be utilized to fulfill two functionalities: (i) extracting the features of various track components to evaluate their health conditions, such as missing or broken spikes, clips, rail surface detect, welding crack, broken ties, etc.; and (ii) identifying rails to guide and navigate the drone within the designated airspace even in GPS-denied environments and under severe weather conditions. The track/rail identification enables automated positioning, navigation, and timing (PNT) determination for flight control (i.e., visual-servoing). The flight routes above the track will be optimized to meet all data acquisition and power consumption requirements for enhanced inspection performance. The flight control will also be augmented with a real-time obstacle (trees, power poles and cables) avoidance algorithm to ensure flight safety in cluttered environments. All inspected data will be immediately processed onboard for track condition assessment without the need for intensive data storage or transferring. Both software and hardware are based on a modular and open-source design, which makes it compatible and transferable to other drone platforms, which to the best of knowledge is unavailable in either commercial or academic sectors.

There are two key components for a practical and effective fully autonomous drone-based track inspection system: autonomous flight control and track component and defect detection in real time. Therefore, we propose to develop the AUTO-inspection system based on the research team's knowledge on advanced computer vision, image processing, pattern recognition, robotics control, and edge AI computing. Recently, the research team has built the very first railroad component image database and released it to the public: github.com/jonguo111/Rail_components_image_data. The research team will enrich the current dataset by adding track images taking by drone with different angles, height, cruising speed, and focus levels to cover possible image variation from a drone. The enriched dataset will be used to train the drone-based computer vision model that can provide critical information for autonomous flight and perform track inspection tasks.

The proposed research will develop a customized, track-oriented high-speed AI-based drone control algorithm for track identification and drone self-navigation. The proposed flight control algorithm is able to 1) recognize tracks from elevated viewing heights and different angles; 2) direct the drone into the designated airspace and cruise along the track within user-defined boundaries; 3) detect obstacles that are within the cruising route and avoid potential impact, and 4) follow the selected track path when multiple tracks are presented. The research team have good understanding of the state-of-art computer vision, AI, and robotics control. Recently publications, pending articles, and related projects sponsor by Army and NSF demonstrate the capability and technology readiness of our research endeavor.

Other than provide navigation information for drone auto-cruising, the developed computer vision model will also perform defect detection, such as missing component, rail surface defect, etc. Our recent studies have successfully achieved real-time instance segmentation with high accuracy and real-time speed on a single GPU, for the first time in railroad inspection and even civil engineering. We have also tested our model with track images taken by drone and successfully performed rail surface detect detection and quantification from track images taken with a variety of viewing heights and angles. The research team also has strong background in image enhancement by handling images taken from different problematic environment, such as low visibility, rainy or foggy weather, low resolution, missed focus and blurry, imbalanced brightness. More importantly, the research team pioneers in object depth estimation, which is the foundation to enable obstacle recognition and impact avoidance re-routing based on drone images.

To enable field practice based on the proposed flight control and track inspection described above, an appropriate mobile edge-computing unit and customizable drone development kit with be fused together with a solid and practical integration strategy which will be devised and developed leveraging our prior experience. The system will be optimized with respect to both detection accuracy and inspection speed. The research team has rich experience in system integration to maximize the performance of both hardware and software.

The proposed autonomous drone-based track inspection system will be developed by leveraging extensive R&D experience of the research team on autonomous flight control, computer vision, and deep learning. The proposed innovation is based on open-source made-in-USA drone platform and low-cost sensors in the market along with AI inference models that will be integrated into a Size, Weight, and Power (SWaP) efficient edge computing device for real-time track inspection and data processing. The research team has experience to develop and package relevant AI software and hardware solutions in prior defense-related and railroad engineering applications, such as autonomous robotics, object detection and identification, and our prior accomplishments on track component inspection. Our industry partners, CSX and SC Railroad Museum, have agreed to provide track access for database enrichment and technology validation. The basic system development is expected to be completed within a period of performance of 12 months, which is the Phase I of the proposed effort. Phase I contains autonomous drone flight control, AI training library establishment, basic AI-based track component detection, and field demonstration. Optional Phase II system development is contingent on availability of additional funding and time, such as drone obstacle avoidance, automatic route selection, drone-based track image enhancement for complex environment, system robustness enhancement and power management optimization, etc. Technical details will be described in Section 3 Technical Approach.

This system will enable groundbreaking capabilities for autonomous flight (Phase I), and real-time, quantitative and visual assessment of track conditions in a complex environment (Phase II). The proposed system adopts modular architecture, which can be easily customized depending on inspection interests, such as detecting and quantifying single or multiple types of track defects, obstacle avoidance, or all-weather inspection, leading to significantly reduced cost of field application.

In summary, the target for Phase I is to mainly develop developed the autonomous drone that is able to recognize and follow the track with compliance of the designated airspace to perform basic track component inspection. The prototype drone will also be developed for a field test to validate the performance of this phase. Future Phase II will focus on expanding the inspection capability, robustness, and routing planning (including obstacle avoidance and multi-track condition path selection).

Work Package 1: Training Image Training Image Library Enrichment. The AI training depends on the quality of the training images. The team will coordinate with industry partners to collect track images using drones to enrich the existing training data repository established by the proposal team. The team will utilize the tracks at South Carolina Railroad Museum and CSX to acquire more representative videos under different light and weather conditions. This will ensure our data repository covers all types of popular fasteners and represents most field track appearances.

Work Package 2: AI and Computer Vision Software Module Development. The high-fidelity computer vision models will be developed and trained using Pytorch (a widely used open-source deep learning library) on the high performance computing (HPC) facility, Hyperion, at the University of South Carolina and the Center for Research in Computer Vision, at the University of Central Florida. TensorRT (an SDK optimized for high-performance deep learning inference) will be used for efficient model deployment on edge devices. The trained model will be used to identify the track from optical images to provide navigation information based on track location and direction.

Meanwhile, track component included in the images will be screened to detect missing or defected component. Note the model training will focus on handling images having inconsistent viewing angles and heights that taken by drones.

Work Package 3: Autonomous Drone and Flight Control Development. Both the software and the hardware platform of the quadcopter drone for autonomous railroad tracking and flight will be developed. The selected open source drone development kit is highly customizable. The drone assembly will be tailored according to the track inspection task, model computing and power consumption level, and airspace restrictions. The vision-based control will be implemented to provide appropriate target position and direction to follow the track using the rail images acquired by onboard vision system. Position and attitude controllers will be developed to actually translate and rotate the drone to the desired location and orientation. User-defined boundaries will guide the drone to cruise along the track within the designated airspace with a proper speed.

Work Package 4: Emergency Landing Protocol. In order to comply with the FAA airspace restrictions, the automatic landing control module will be developed to allow the drone to execute the emergency landing protocol safely. Different emergency handling methods will be developed to address two distinct scenarios of emergency.

When the navigation system, especially the onboard camera is still functional, visual simultaneous localization and mapping (SLAM) is the most promising approach for the current application, which could minimize the impact and damage to the drone during emergency landing. However, when the entire navigation system including the onboard cameras are anomalous or failed, an algorithm will be developed to immediately adjust the attitude of the drone and for “hard” vertical landing.

Work Package 5: System Integration and Field Testing/Validate. Upon the completion of the tasks above, the research team will take a prototype autonomous drone system to a mainline track provided by the industry partner or any FRA designated track segment for testing and validation in the field.

Work Package 6: Track-oriented Image Enhancement. Railway track appears to be similar due to the relative consistent track structure. However, the actual track appearance varies significantly due to a variety of factors and the variation in track images put challengers in target recognition and identification. For example, the same rail surface may look quite differently at different time due to the sunlight intensities and angles. Fasteners may be mixed used in the same track segment. Unfavorable weather conditions may jeopardize image qualities, such as rain, fog, and wind, causing images to be blurry or noisy. In the field, track appearance would not be consistent. Thus, a practical inspection solution should be able to maintain its detection accuracy under the complex field environment. The research team has successful experience with image enhancement in other object detection applications before. We will extend our previous knowledge to develop track-oriented image enhancement algorithms to handle images under a variety of unfavorable conditions, considering both camera and environmental issue, to make the developed track inspection system be deployable in different tracks under different environments.

Work Package 7: Image-based Object Depth Estimation. All images taken by an ordinary camera are 2-dimensional image and relative distance between any objects can only be estimated within the plane. The depth information is hard to be determined. There are some proposed solutions using specialized cameras or Lidar, but the equipment cost, power consumption, and inconsistent performance make it impractical for autonomous drone platform.

However, it is critical to obtain the object depth in the images to facilitate obstacle avoidance if a potential thread is detected within the cruising path. The research team pioneers in the object depth estimation from ordinary images and the previous development has demonstrate the reasonable performance of the developed model in analyzing the videos taking from a vehicle moving at different speeds. For this optional work package, the team will develop a special object depth estimation module to integrated with the image processing model to not only detect any obstacles but also determine the distance of the potential obstacle to the drone based on drone collected images.

Work Package 8: Automatic Obstacles Avoidance. Based on the available image-based depth estimation, an extra flight control module will be developed to enable the autonomous drone to avoid potential impact with the detected obstacles, such as tree, bridge, power poles or cables, and billboard, etc. The original flight control module developed in Phase I Work Package 3 would position the drone to cruise along the center of the track at the appropriate height in order to better comply with the airspace restrictions and mitigate potential disturbance such as gust. However, the planned route could be blocked by one or multiple obstacles at a certain location and the drone needs to immediately respond to the detected threat, determine an alternative route, and maintain airspace compliance in order to avoid potential impact in time. This extra flight control module will be developed based on highly efficient, rapid algorithm to generate the best alternative route with consideration on the obstacle size, the distance between the obstacle and the drone, and the cruising speed and airspace restriction of the drone. The maneuver direction and speed will be updated in real-time as the drone is approaching the obstacle.

Work Package 9: Route Sticking and Track Selection for Multiple Track Presence. For revenue service main lines, there is typically more than one track along the route. Turnouts and crossings are also expected. The presence of more than one track in the same or different directions challenges the autonomous drone inspections system. The developed system needs to be able to follow the desired track without entering a wrong route. The proposal team will develop a novel track following algorithm to enable the developed system to remain on the desired track and allow the human operator to make a selection if there is no pre-defined track preference. The proposal team has experience on autonomous robotic navigation algorithm development for complex route identification and robust route recognition.

Work Package 10: System Optimization and Field Test. After validating the performance in Phase I and the completion of the selected modulus in Phase II, the research team will optimize the system by balancing the computational cost, power assumption, and inspection accuracy and range. The research team will coordinate with FRA and industry part to deploy the prototype system to a revenue track to validate and demonstrate the performance of the enhanced capability developed in Phase II.

Work Package 1—Training Image Library

Work package overview: The computer vision model in this project is for detection track for self-navigation and its component for track inspection with the on-board camera of a drone. Thus, the training dataset need to be established with images taken from drones. Different from the traditional image datasets for computer vision model training purpose that typically having high-quality images with consistent shooting angle and distance, this image dataset should cover all possible shooting angles and distance from a drone. Depending on the cruising speed, the focus would also vary. The research team will coordinate with the industry partners to take real images from the field to ensure data representation. All images will be processed to the quality that meets computer vision and AI training standards. Note the research team recently has built railroad component image databases before. The track images taken from drones will be used to enrich the training image library to meet the needs of this proposed project.

Scope Summary:
Identify track component of interest.
Drone Image collection from the field at different locations.
Image processing according to AI development requirements.
Training library enrichment.
Organization of project update meetings with FRA and Industrial Partners.

Deliverables:
Drone Based Track Image Collection.
Training Image Library.
Project update meetings with FRA and Industry Partners.

### Work Package 2—AI-based Track Component Detection

Work package overview: With the dataset containing drone-based track images, an AI-based track detection model for real-time recognition will be developed. The research team will explore the features of the track with popular deep learning neural network architectures and develop a tailored model by customizing the model structure to find the most suitable architecture for track recognition. The new network will be developed to achieve real-time detection and recognition in order to provide timely information for the drone to navigate itself and identify any potential track component defects. Note the research team has rich experience in convolutional neural network (CNN) object detection model development, the research team has developed several track inspection models in the past and achieved real-time inference speed. The team also developed other real-time detection models for the application of object detection in aerial images and action detection in videos.

Scope Summary:
CNN models review and comparison.
Trial model development with drone images.
Trial model training and performance check.
Trail model improvement
Improved model training and performance check
Model Finalization
Finalized Model training and performance check
Organization of project update meetings with FRA and Industry Partners.

Deliverables:
Trial model, performance report, and model improvement plan.
Improved model, performance report, and model improvement plan.
Finalized model, and performance report

Work Package 3—Autonomous Drone and Flight Control Development

Work package overview: With the track component detection and computer vision model developed in Work Package 2, this work package aims to develop a computer vision-guided autonomous drone that is able to navigate itself along the railroad track using the optical images and stays within the designated airspace. This package enables track identification, feature fusion, flight control, and real-time computing for the autonomous drone to cruise in GPS denied areas and comply with FAA airspace restrictions.

Scope Summary:
Initial drone kit assembling
Flight control algorithm
Waypoints determination by the computer vision model for flight control
Algorithm optimization for real-time data exchange and computing
Prototype drone and edge computing module assembling
Laboratory trial test
Organization of project update meetings with FRA and Industry Partners.

Deliverables:
Initial drone assembly.
Flight control program.
Integrated software package for image-guided navigation flight control.
Prototype drone

Work Package 4—Emergency Landing Protocol

Work package overview: This work package mainly focuses on developing an automatic landing module to ensure the drone to land safely in case of emergency, i.e., leaving designated airspace. The signal will be immediately sent or automatically triggered in case of emergency to perform the landing based on the predefined protocols to comply with the FAA airspace restrictions and to prevent the drone from causing catastrophic events.

Scope Summary:
Define cases to perform emergency landing.
Safe landing zone detection algorithm development.
Visual servoing and decision making for automatic landing development.
Reliability and safety testing.
Organization of project update meetings with FRA and Industry Partners.

Deliverables:
Vision- or non-vision-based safe landing zone detection algorithm.
Autonomous landing control algorithm.

Work Package 5 U System Integration and Field Testing

Work package overview: In this work package, the research team will coordinate with the industry partner, to conduct a field test to examine the actual performance in real environment. A integrated autonomous drone system will be deployed to the selected track to demonstrate its autonomous flight and inspection performance. Necessary improvements of the system will be made based on the field test result.

Scope Summary:
Select test site and identify test track.
Assemble the prototype drone.
Conduct the field test.
Field test performance evaluation and possible improvement plan.

Work Package 6 UTrack-Oriented Image Enhancement

Work package overview: In this work package, the research team will develop track-oriented image enhancement algorithm to handle images under a variety of unfavorable conditions, considering both camera and environmental issue,
to make the developed drone system be deployable in different tracks under different environments to handle potential
problematic images under different visibility conditions.

Scope Summary:
Track image collection under challenging environments.
Image enhancement algorithm development.
Implementing track-oriented image enhancement algorithm into the computer vision
model
Organization of project update meetings with FRA and Industry Partners.

Deliverables:
Supplement track image dataset.
Image enhancement algorithm.
Upgraded computer vision model.

Work Package 7 UImage-Based Object Depth Estimation

Work package overview: In this work package, the research team will develop another supplement computer vision module to enable the capability to calculate the depth of potential obstacle objects along the drone path based on the optical images. This way, the drone can estimate the distance between the obstacle objects and itself without the need to load other sensors to save both the cost and battery consumption. The object depth estimation is critical to enable the developed drone system to avoid potential collisions automatically.

Scope Summary:
Image-based depth estimation algorithm development.
Algorithm calibration with the existing camera in the developed drone system.
Implementing depth estimation algorithm into the computer vision model

Deliverables:
Image-based depth estimation algorithm.
Upgraded computer vision model.

Optional Work Package 8 UAutomatic Obstacle Avoidance

Work package overview: Based on the work package 7, the research team will develop a flight control module for automatic obstacle avoidance. The new flight control module utilizes the calculated distance between the drone and the detected obstacles and the current flight conditions of the drone to identify an alternative route to avoid potential collision with the obstacles, such as trees, billboards, overhead bridges, and power poles. The maneuver direction and speed will be updated in real-time as the drone is approaching the obstacle. If the obstacle is not possible to be avoided without breaking the airspace restrictions, the emergency landing protocol will be activated and reported.

Scope Summary:
Obstacle avoidance control algorithm development.
Detour optimization and integration with the emergency landing protocol.

Deliverables:
Automatic obstacle avoidance algorithm.
Upgraded drone flight control program.
Project update meetings with FRA and Industry Partners.

Optional Work Package 9 URoute and Track Selection for Multiple Track Presence

Work package overview: This work package is to solve the route selection problem when there are multiple potential tracks to follow, especially at the turnouts and crossings. The research team will develop a flight control module to enable the drone to keep the pre-defined route preference or allow the end-user to decide at each location. The proposal team has experience on autonomous robotic navigation algorithm development for complex route identification and robust route recognition. We will extend our previous experience in similar applications for ground robots to drone system.

Scope Summary:
Route select algorithm development.
In flight route selection and execution algorithm development.
Organization of project update meetings with FRA and Industry Partners.

Deliverables:
Automatic route following and selection algorithm.
Upgraded drone flight control program.

Optional Work Package 10 USystem Optimization and Field Test

Work package overview: After the successful completion of the previous work packages, the research team will perform overall system optimization to fusion all the individual modules together. The power consumption and inspection performance will also be optimized. The updated autonomous drone inspection system will be able to avoid obstacle automatically while performing the autonomous track inspection tasked and can be deployed into a more complex environment.

Scope Summary:
System integration.
System optimization.
Conduce field test.
Organization of project update meetings with FRA and Industry Partners.

Deliverables:
Optimized drone system after Phase II development.
Field performance validation.

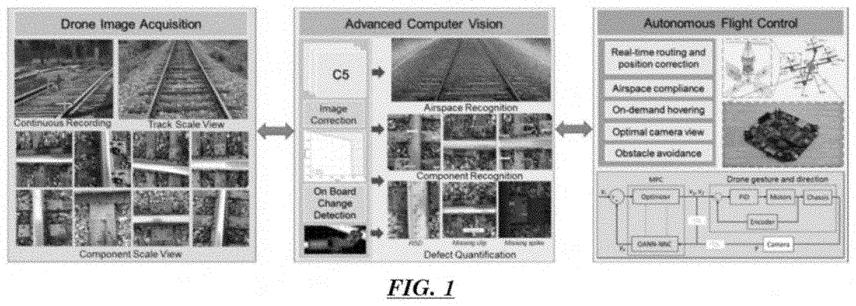

The proposed research effort consists of five modules for Phase I: Module I: Training Image Library; Module II:
AI-based Track Component Detection; Module III: Autonomous Drone and Flight Control; Module IV: Emergency
Landing Protocol, and Module V: Field Test. The overall concept is given in FIG. 1.

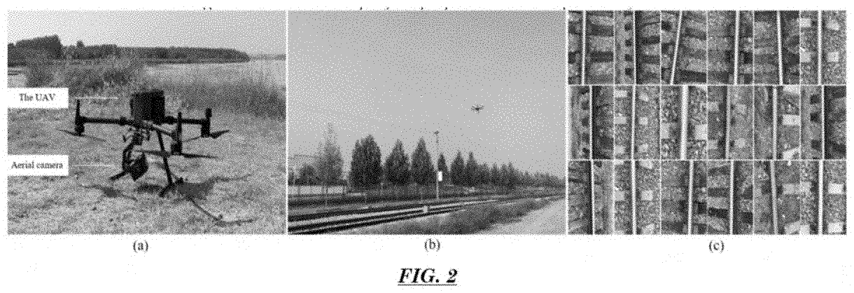

Module I. Training Image Library Development: The objective of this module is to establish specialized drone-based track image database for convolutional neural network (CNN)-based computer vision model training. With a selected drone, track images will be taken with the on-board camera with different angles, height and cruising speed to mimic the real operation condition of the drone on top of the track. This way, all images would represent the actual view of the candidate drone's camera system. To represent the real field application scenario, the camera will record videos continuously. Individual frames will be extracted and converted to a specific resolution and size following the requirements of the selected CNN model training. For example, YOLOv3 requires the training images to be converted to 512×512. All the images will need to be labelled to specify the category of the component. A popular labeling tool, labelme (github.com/wkentaro/labelme), will be used to label the component of interest. The output of labelme is in the JSON format, while the labels for the training of a specific CNN model could be different, such as YOLOv3 and YOLOv4 need the input to be in txt format. Therefore, another conversion will be performed before the CNN model training. An example to use drone cameras to take track images and establish the training library is illustrated in FIG. 2.

Theoretically, the more images are desirable subject to the constraint of time and labor consumption. Thus, image augmentation may be employed during the process to reduce the load of image collection while maintaining the library quality.

Module II. AI-based Track Component Detection: The proposal team has extensive experience in computer vision and deep learning technologies for rapid image processing and has developed a variety of applications in multiple disciplines such as object detection, target recognition, anomaly detection, crossing safety, and traffic routing that have been strongly supported by Federal Railroad Administration, National Academy of Science, Army Research Laboratory, National Science Foundation, and others. Furthermore, the team has made remarkable progress (Guo et al. 2021 a&b, Wu et al. 2021 a&b) and demonstrated strong capability of anomaly detection for the track components, such as fasteners, spikes, rail surface, in recent publications. We will leverage our extensive experience on convolutional neural networks (CNNs) for video processing to adapt state-of-the-art or develop new deep learning methodologies for automated image collection, processing, analysis, and identification for trustworthy situational awareness assessment and track condition evaluation. Specifically, we will develop a pixel-level detection system by using a tailored instance segmentation model to detect track components in a fast and accurate fashion.

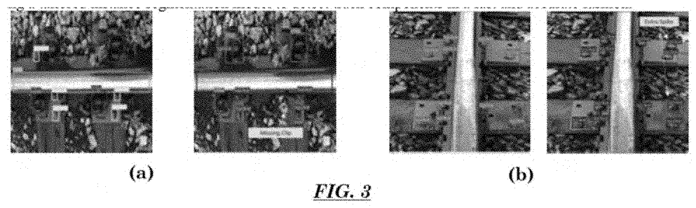

FIG. 3 presents examples of component detection and condition evaluation. Both missing and added components can be successfully detected. The proposed CNN extracts feature from track images, predicts objects at different scales utilizing a feature pyramid network, and generates high-quality prediction by evaluating the probabilities of classification and detection. The training processes for this system are carried out offline using a high-performance computing workstation, and the trained AI model can be deployed in a heterogeneous edge computing device for real-time detection and evaluation. The team also has extensive experience and prior efforts in deep neural networks compression and pruning for computational and memory efficient deployment on resource-constrained embedded devices (e.g. NVIDIA Jetson).

For this proposed work, the challenge is associated with the consistence and quality of imagery data. We will use the onboard camera of the drone equipped with vibration-mitigation gimbal for videos/images acquisition. Due to unpredictable environmental issues, such as wind, sunlight, etc. and vibration of the drone itself, it is impossible to have track images with consistent quality. This is exactly the reason why many earlier studies failed, which tried to directly use existing models developed for dataset of good and consistent qualities to analyze images with heterogeneous qualities taken by drones. Fortunately, the proposal team has accumulated experience in solving the drone image inconsistency issue with an exclusive dataset of track images taken by drones and developed machine learning algorithms for image correction.

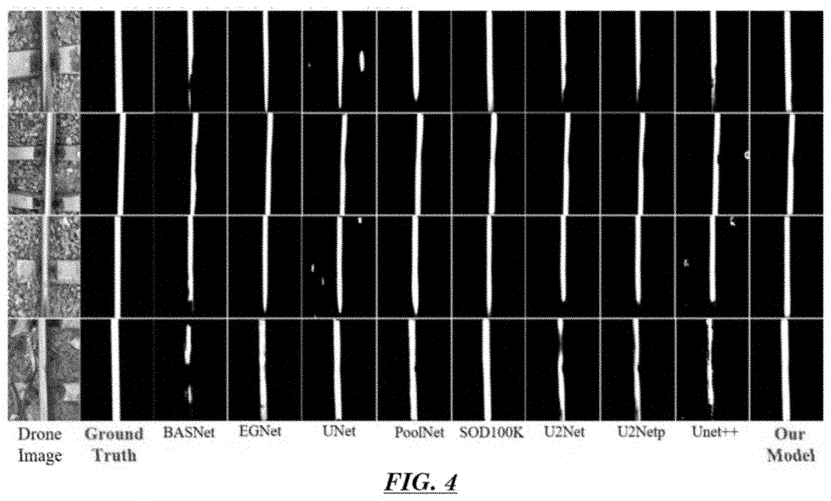

Popular non-edge-aware saliency detection frameworks such as UNet, U2Net and UNet++ may detect the rail surface with blur, incomplete, or even incorrect boundaries due to the lack of auxiliary rail edge guidance information. A good network should be able to model complementarity between the rail surface information and the rail edge features, and sufficiently leverage the complementary information to accurately produce the rail surface with fine boundaries. This also serves as the stepping stone for autonomous flight control. Third, the brightness of the track images fluctuates because of varying sunlight intensities. Also, the pixel level intensities of track components are often disrupted by shadows of surroundings along the track and variations in their reflectance properties. Therefore, it is not surprising that the existing pixel-wise FCN-based methods yield inconsistency in detection performance for different regions of the track components. We propose a novel fully convolutional network (FCN), which can fully utilize the complementarity between rail edge information and rail object information for accurate surface segmentation of rails and other track components. This FCN can model saliently the complementary rail surface information and the rail edge features for preserving rail boundaries in the images. The network architecture is based on a backbone introducing the enhanced residual block (ERB), and can optimize the detection tasks between the surface and the edge by forcing them to mutually complement each other. This new architecture could remarkably improve the accuracy of rail surface and other track components detection. FIG. 4 gives an example of the proposal team's existing work on rail surface detection versus other state-of-the-art models.

Module III. AI-based Visual Servoing for Flight Navigation

We propose to develop visual servoing (or vision-based control) to guide and navigate the drone by following the rails of the track for fully autonomous inspection. Compared to other positioning techniques such as GPS, markers, or beacons, our method directly analyzes the images acquired onboard, and features several advantages, such as low cost and salient reliability and field-deployability in harsh and GPS-denied environments.

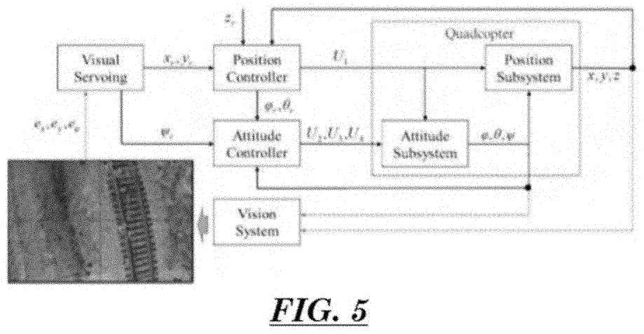

The overview of the proposed autonomous flight control is depicted in FIG. 5. Three controllers will be implemented, including: (1) vision; (2) position; and (3) attitude. The vision controller aims to position the center of the image at the midpoint of the two rails, while being vertically aligned with the track (i.e., image being parallel to the track).

Seen from bottom left corner of FIG. 5, three error values (ex, ey, eψ) are measured with respect to the desired center location, indicated as the red dot. These error values are supplied to the controller, and the desired horizontal positions (xr, yr) also named waypoints, and the yaw angle (ψr) of the quadcopter are generated The position controller receives the desired horizontal positions, and the desired altitude (zr) which can be defined by the user based on the regulations and practical constraints for flying quadcopter over the railroads. The position controller then generates the thrust (U1) supplied to the quadcopter, and the desired roll and pitch angles (φv, θr) that need to be passed on to the attitude controller. Lastly, the attitude controller attempts to rotate the quadcopter to the desired roll, pitch, and yaw angles by generating the appropriate torques (U2, U3, U4), which are applied to the quadcopter. Among various control methods, the most robust and well-known PID (proportional integral derivative) control scheme will be implemented for all three controllers due to the unique aspects of track inspections. Once the entire control scheme is successfully demonstrated, other control techniques such as linear quadratic regulator (LQR), adaptive, intelligent (fuzzy logic and neural network), and model predictive control (MPC) will be explored to enhance the tracking performance (i.e., faster convergence and smaller tracking error).

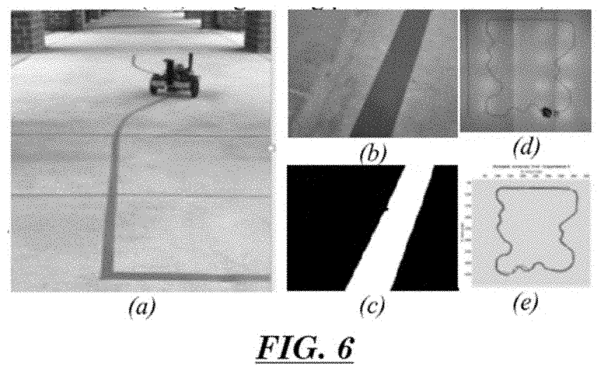

In previous research, the team has developed and demonstrated a plug-and-play (PnP) tool/platform based on online machine learning for real-time monitoring, prognostics, and control of a ground robot platform using embedded-AI edge computing (Nvidia Jetson TX2) for field-deployable decision-making and applications. This ground robot performs a visual servoing for path tracking through a camera (FIG. 6 at a) based on the neural network-based double loop control scheme (similar to the proposed one). FIG. 6 at b shows the original image acquired onboard; (c) image effectively converted into the gray scale even with the interfering floor appearance; (d) demonstration of the ground robot on a very tortuous path, which is monitored by three low-cost, overhead cameras. The visual feeds from the three cameras are fused together to increase the field of view (FOV) and resolution; and (e) comparison of the robot trajectory (red) to the track (blue). It should be noted in this ARL project, the requirement for tracking precision is far more demanding (˜cm) than the railroad track following in the proposed effort. Therefore, it is anticipated that the control framework established in our ARL project can be immediately translated to the research for FRA.

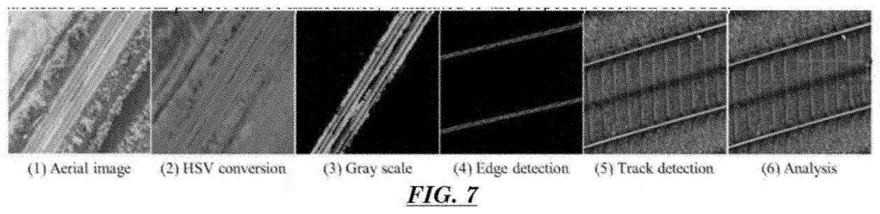

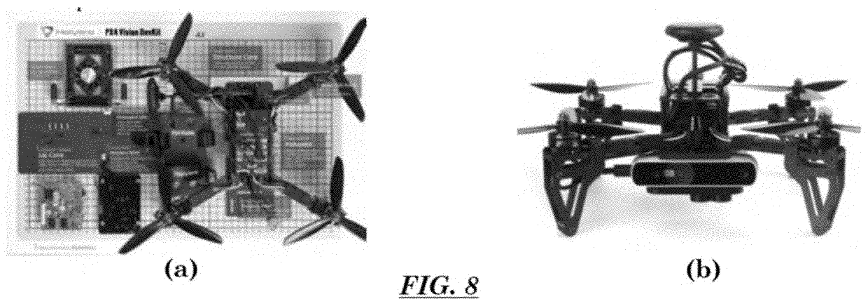

Image Processing and Visual Servoing: Image processing is critical for visual servoing, since the information extracted from the image acquired onboard will be used as the feedback term. Recently, a robust method for rail track extraction using drone images was proposed and studied, and the similar process will be employed as shown in FIG. 7. At first, the image taken from the quadcopter is converted to the HSV (hue, saturation, and value) space to minimize the effect of varying illumination conditions throughout the day or at different weather conditions. Since the rail is made of steel, it appears to be within a range of the HSV space, allowing to enhance its contrast and extract it from the surroundings. The extracted image is then converted to gray scale for further processing. The edge detection is applied to the gray scale image, which identifies the boundaries of the track, see FIG. 7. Finally, the detected rails are utilized to locate the desired position and the orientation of the track with respect to the current quadcopter state. The team has applied similar techniques to track-following robots as shown in FIG. 6. Hardware Platform: The initial development of the proposed autonomous inspection system will be based on the “PX4 Vision” platform as shown in FIG. 8. Utilizing such an all made-in-USA open-source platform for prototyping will not only allow rapid technology development, but also avoid cybersecurity issues with foreign vendors. PX4 Vision is built around the popular Pixhawk 4 flight controller that provides favorable features such as excellent compatibility and connectivity, ease of operation, and robustness. The autonomous visual servoing and tracking module will also be developed and integrated on PX4 Vision. However, the AI and computer vision module (Module I) for online inspection may require more computing power with GPU to enable parallelized inferences of high-resolution images. Thus, for module integration, we propose to replace the onboard UP Core with NVDIA Jetson AGX Xavier, which includes 8-core ARM v8.2 64-bit CPU and 512-core Volta GPU with Tensor Cores to enable highly parallel computing. On such an edge computing platform, flight control, visual servoing and obstacle avoidance algorithms can be deployed, and communication with the flight controller will be via the Mavlink protocol.

Emergency Landing Protocol:

In order to comply with the FAA airspace restrictions, the automatic landing control module will be developed to allow the drone to execute the emergency landing protocol safely. Two scenarios that require different emergence handling methods are proposed. In the first, the drone deviates from its desired course and leaves designated space, which may be caused by sudden strong wind or change in environment settings, and/or accumulated drifting errors, although the navigation system may still remain fully or at least partially functional (in particular, the onboard camera system). In this circumstance, planned emergency landing can be executed to avoid damage or loss of the drone. Considering the fact that the railroad inspection is performed outdoors and there will not be any stations available with predefined markers or shapes, the safe landing zone (SLZ) must be identified from the onboard camera. Among different vision-based landing zone detection methods, visual simultaneous localization and mapping (SLAM) seems to be the most promising approach for the current application. Visual SLAM constructs the 3D map using image data, which can be analyzed to find the SLZ. Once the landing location is confirmed, PID control will be resumed for automatic landing. The controller will position the drone right above the SLZ, and gradually lower it. While landing, the drone will be centered at multiple altitude levels to ensure the landing on the defined spot. This emergency landing protocol also applies to the situation harsh environmental conditions (i.e., hurricanes, tornadoes, wildfire, etc.) forms or occurs rapidly without warning or notification. The second worst scenario that may result in intrusion into the non-designated airspace is due to the complete failure of the onboard cameras, visual-servoing and navigation system, and the drone (even when a pilot is involved) is almost blind and unaware of the situation. Then our flight control system will adjust the attitude of the drone, regain its horizontal position, deaccelerate for less impact to prepare for “hard” vertical landing.

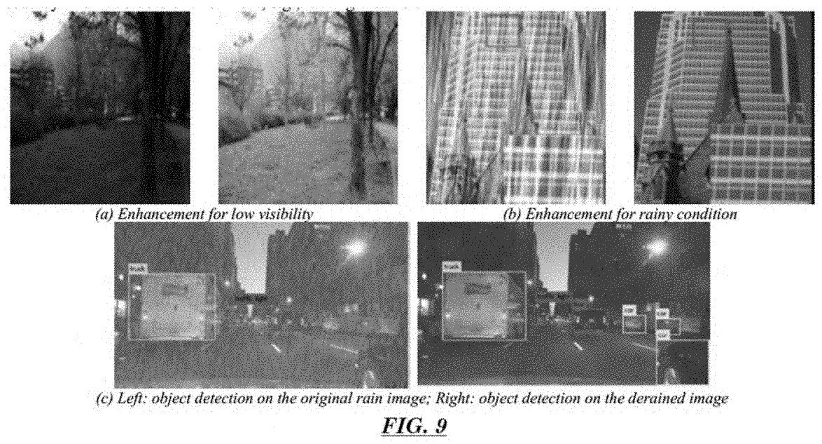

Track-oriented Image Enhancement: Railroads go through different territories that may have different geographic and climate characteristics. Thus, it is not reasonable to assume the track appearance would remain constant. The images taken by the drone may face different challenges, such as heavy fog, rainfall, smog, dust, low visibility, high reflection, etc. It is also possible the focus level may not be the best during the drone cruising at different speeds and heights. To extend the deployability of the autonomous drone, we proposed to develop tailored computer vision enhancement model to handle “problematic” track images. The team has developed several effective deep learning-based image enhancement approaches (including image low-light enhancement, image deraining, and image super-resolution) which can greatly promote the performance of the downstream vision tasks such as object detection and semantic segmentation. We show a few examples of image enhancement using our methods in FIG. 9 (a) and (b). Moreover, FIG. 9 at (c) clearly demonstrates that the enhanced image can significantly improve the object detection accuracy in unfavorable environment, e.g., raining weather.

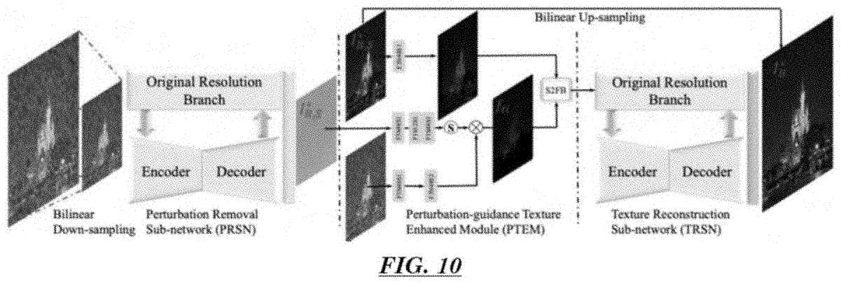

The team will develop a unified framework that can perform various image enhancements including deraining, dehazing, low-light enhancement, and image super-resolution. Unlike existing solutions, which only focus on perturbation removal, our proposed method considers the correlation between perturbation removal and background restoration to generate high-naturalness contents of texture, color, and contrast. To achieve this goal, the proposed image enhancement network consists of two sub-networks for perturbation elimination and texture reconstruction tasks, respectively. The overall framework is depicted in FIG. 10.

We better illustrate the network architecture, we take the image deraining task as an example. Concretely, it consists of a perturbation removal sub-network (PRSN), a perturbation-guided texture enhancement module (PETM) and a texture reconstruction sub-network (TRSN). PRSN learns the corresponding perturbation distribution I*_{R,S} from the down-sampled input I_{D,S}, and produces the coarse restored results I*_{B,S} by subtracting I*_{R,S}. Then PTEM takes I*_{R,S} and the original image I_{D} as inputs to learn the texture information fₜᵢ, followed by a texture reconstruction sub-network (TRSN) for high-frequency detail recovery and resolution enhancement. It is worth noting that the proposed method operates on the down-sample input images (i.e., low resolution space), the overall computational complexity of the method is greatly reduced for fast inference speed.

Image-Based Object Depth Estimation.

The research team will develop an object depth estimation module to enable the capability to calculate the depth of potential obstacle objects along the drone path based on the optical images. This way, the drone can estimate the distance between the obstacle objects and itself without the need to load other sensors to save both the cost and battery consumption. The object depth estimation is critical to enable the developed drone system to avoid potential collisions automatically.

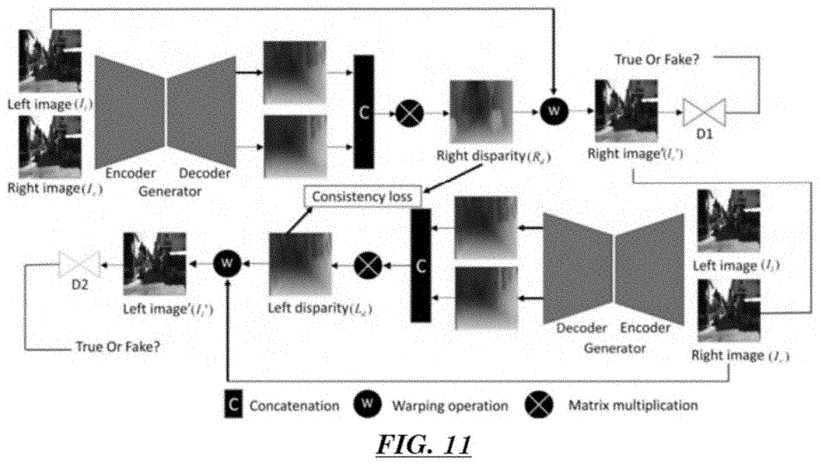

We propose an unsupervised depth estimation approach by estimating disparity maps from two different image views (rectified left and right images) of the calibrated stereo camera, making ground truth depth data not required for training. The overall pipeline is presented in FIG. 11. Specifically, the architecture takes calibrated stereo camera images (pairwise) as input to estimate disparity map through image synthesis. The generator network consists of two sub-networks. The upper sub-network generates a right disparity map (R_{d}) with the left input image (Iₗ) and synthesizes a right image view (I′ᵣ) through the warping operation (change pixel locations to create a new image) w, i.e., I′ᵣ=w(R_{d}, Iₗ). Similarly, the lower sub-network generates a left image view, I′ₗ=w(L_{d}, Iᵣ). The reconstruction loss is implemented between the synthesized and input images to optimize the generator networks. The discriminator, D1, D2, is used to discriminate if the synthesized image, I′ₗ, I′ᵣ, is fake or not. Moreover, since two disparity maps R_{d} and L_{d} are generated based on the left and right input view, respectively, we further impose a consistency loss between them to reduce the discrepancy. The final depth map is the average of the predicted two disparity maps R_{d} and L_{d}.

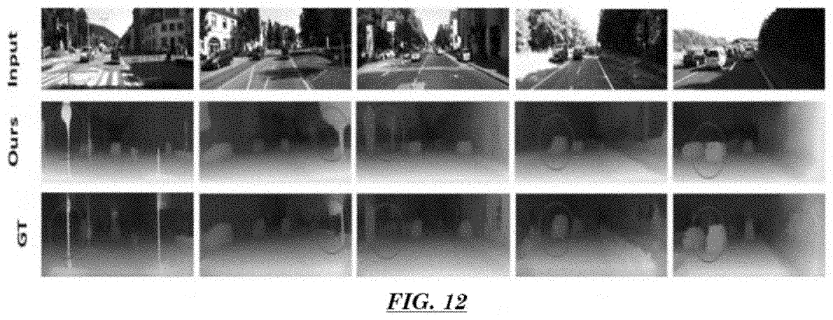

Preliminary results: We evaluate our proposed method on the standard depth estimation benchmark KITTI dataset, which contains several outdoor scenes from LIDAR sensor and car-mounted cameras while driving. We show several examples of depth estimation from images in FIG. 12. Compared to the ground truth (GT), the predicted depth maps of our unsupervised method are very accurate with a high level of detail. A video demo is also provided here: youtu.be/ieb81yDDsM4

On a single Nvidia GTX 1080Ti GPU (11 GB of memory), our method achieves an inference speed of 10PFS on images with 1224×368 pixels of resolution. To further improve the inference speed, we propose two solutions: (1) a highly compact and light-weight CNN model-MobileNetV3 will be used in our method as the network backbone for computation efficiency, and (2) network quantization. The fundamental idea behind quantization is that if we convert the weights and inputs into integer types, we consume less memory and on certain hardware, the calculations are faster. The proposal team will compress the network by quantization based on the team's prior work for high computational efficiency while maintain the desired accuracy.

Automatic Obstacle Avoidance: One potential issue of autonomous drone track inspection is the potential obstacle within the airspace along the track. Considering the cluttered railroad environments, one essential feature of the drone is to automatically avoid those obstacles such as trees, power poles, bridges, or cables. Based on the object depth estimation module developed in Module VII, the front facing Structure Core depth stereo camera and the downward facing optical flow camera in PX4 are mounted on the frame, enabling to extract position information relative to the obstacles for autonomous railroad tracking that will be used in the object avoidance algorithms. This feature will allow the quadcopter to navigate around obstacles by modifying the waypoints, e.g., lower its altitude but still within the acceptable bounds when following the identified tracks. Note that PX4 also supports collision avoidance in off board mode that allows using the built-in or third-party avoidance algorithms on a companion computer (e.g., our Jetson AGX Xavier).

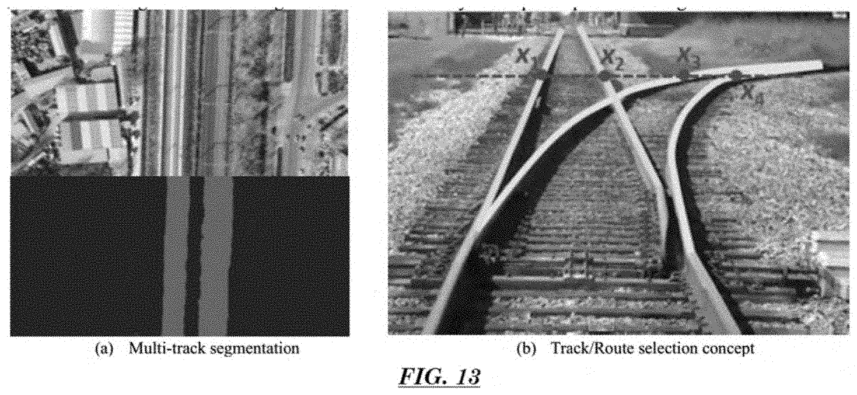

Route and Track Selection for Multiple Track Presence: There are turnouts and crossings along the track to facilitate connection between different tracks. The locations having multiple route selections (i.e., turnouts or crossings) are ubiquitous for direction switch, which, however, pose a challenge to autonomous drones because the flight controller has no preference or prior knowledge which track to follow. We propose a novel algorithm that will be implemented as a ROS node to tackle such a challenge in four steps: (1) the human operator needs to assess the number of the turnouts within the segments of the rail to be inspected and make the decision which track to follow at the turnouts before the flight. The decision will be stored onboard; (2) during the flight, the image processing and visual servoing algorithm above will be turned on for track detection. When two or more pairs of tracks are detected, the flight controller invokes the track selection/decision algorithm; (3) the horizontal values of each track at the top half of the image will be extracted (i.e., x1-x4 as shown in FIG. 13), and these tracks will be sorted from the left to the right (see the red dash line); and (4) the algorithm then commands the quadcopter to follow one of the tracks, i.e., the left- or the right-most according to the decision saved by the inspector prior to the flight.

System Optimization and Field Test: After the successful completion of the previous work packages, the research team will perform overall system optimization to fusion all the individual modules together. The power consumption and inspection performance will also be optimized. The updated autonomous drone inspection system will be able to avoid obstacle automatically while performing the autonomous track inspection tasked and can be deployed into a more complex environment.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A drone-based railway track inspection system comprising:
at least one drone comprising at least one computing platform;
the at least one computing platform further comprising;
at least one surveillance unit;
at least one communication unit;
at least one computer vision unit; and
at least one autonomous flight control unit;
wherein the at least one surveillance unit, at least one communication unit, the at least one computer vision unit, and the at least one autonomous flight control unit are in communication with one another;
wherein the at least one computer vision unit is configured to:
extract features of at least one track component to evaluate at least one health condition of the at least one track component; and
identify a least one railway in order for the at least one drone to navigate.

2. The drone-based railway track inspection system of claim 1, wherein the drone navigates without access to GPS positioning.

3. The drone-based railway track inspection system of claim 1, further comprising the at least one flight control unit employing a real-time obstacle avoidance system.

4. The drone-based railway track inspection system of claim 1, further comprising an onboard processing unit, in communication with the at least one computing platform, that processes inspected data immediately to provide real-time track condition assessment without requiring the inspected data to transfer away from the drone.

5. The drone-based railway track inspection system of claim 1, wherein the at least one health condition of the at least one track component includes identifying at least one item missing from the at least one track component or identifying at least one defect in a rail surface.

6. The drone-based railway track inspection system of claim 1, further comprising a data repository, in communication with the at least one computing platform, wherein the data repository contains field track appearance data to compare with real-time data obtained by the drone-based railway track inspection system.

7. The drone-based railway track inspection system of claim 1, further comprising an automatic landing control module, in communication with the at least one computing platform, to execute an emergency landing protocol.

8. The drone-based railway track inspection system of claim 1, further comprising an object depth estimation module, in communication with the at least one computing platform, to detect at least one oncoming obstacle in a drone flight path as well as to determine a distance of the at least one oncoming obstacle to the drone.

9. The drone-based railway track inspection system of claim 1, further comprising at least one non-edge-aware saliency detection framework, in communication with the at least one computing platform, to detect the rail surface under blurred, incomplete, or incorrect rail boundary visual information.

10. The drone-based railway track inspection system of claim 9, further comprising the least one non-edge-aware saliency detection framework configured to reproduce the rail surface in real-time.

11. A method for using a drone to inspect railway tracks comprising:
flying at least one drone over at least one railway;
wherein the at least one drone includes at least one computing platform;
the at least one computing platform further comprising;
at least one surveillance unit;
at least one communication unit;
at least one computer vision unit; and
at least one autonomous flight control unit;
wherein the at least one surveillance unit, at least one communication unit, the at least one computer vision unit, and the at least one autonomous flight control unit are in communication with one another;
wherein the at least one computer vision unit is configured to:
extract features of at least one track component while flying over the at least one railway to evaluate at least one health condition of the at least one track component; and
identify the at least one railway while flying over the at least one railway in order for the at least one drone to navigate.

12. The method for using a drone to inspect railway tracks of claim 11, wherein the drone navigates without access to GPS positioning.

13. The method for using a drone to inspect railway tracks of claim 11, further comprising the at least one flight control unit employing a real-time obstacle avoidance system.

14. The method for using a drone to inspect railway tracks of claim 11, wherein the at least one computing platform further comprises an onboard processing unit that processes inspected data immediately to provide real-time track condition assessment without requiring the inspected data to transfer away from the drone.

15. The method for using a drone to inspect railway tracks of claim 11, wherein the at least one health condition of the at least one track component includes identifying at least one item missing from the at least one track component or identifying at least one defect in a rail surface.

16. The method for using a drone to inspect railway tracks of claim 11, wherein the at least one computing platform further comprises a data repository in communication with the at least one computing platform wherein the data repository contains field track appearance data to compare with real-time data obtained by the drone-based railway track inspection system.

17. The method for using a drone to inspect railway tracks of claim 11, wherein the at least one computing platform further comprises an automatic landing control module to execute an emergency landing protocol.

18. The method for using a drone to inspect railway tracks of claim 11, wherein the at least one computing platform further comprises an object depth estimation module to detect at least one oncoming obstacle in a drone flight path as well as to determine a distance of the at least one oncoming obstacle to the drone.

19. The method for using a drone to inspect railway tracks of claim 11, wherein the at least one computing platform further comprises at least one non-edge-aware saliency detection framework to detect the rail surface under blurred, incomplete, or incorrect rail boundary visual information.

20. The method for using a drone to inspect railway tracks of claim 19, further comprising the least one non-edge-aware saliency detection framework configured to reproduce the rail surface in real-time.
